(19) United States
(12) Patent Application Publication
(10) Pub. No.: US 2014/0058974 A1
(43) Pub. Date: Feb. 27, 2014

(54) METHOD FOR EVALUATING CONSENSUS CREDIT SPREAD

(71) Applicants: SARAH BILLER, Boston, MA (US); Raymond Smith, Amesbury, MA (US); Sheamus McGovern, Belmont, MA (US); Angela Atherton, Gaithersburg, MD (US)

(72) Inventors: SARAH BILLER, Boston, MA (US); Raymond Smith, Amesbury, MA (US); Sheamus McGovern, Belmont, MA (US); Angela Atherton, Gaithersburg, MD (US)

(21) Appl. No.: 13/593,050

(22) Filed: Aug. 23, 2012

(51) Int. Cl. G06Q 40/06

(52) U.S. Cl. CPC G06Q 40/06
USPC 705/36 R

(57) ABSTRACT

A financial metric application running on a computational device has a client registration module, a market factor measure collection module, a synthesis module and a reporting module. A plurality of pre-qualified financial professionals submit to the financial metric application collection module market factor measures which they believe contribute to a fixed income financial instrument metric, and the synthesis module comprising the application operates to evaluate the metric against each of the submitted market factor measures to determine the contribution each measure makes to the financial metric.

### CROSS REFERENCE TO RELATED APPLICATIONS

This application claims the benefit under 35 U.S.C. §119(e) of U.S. Provisional Patent Application Ser. No. 61/526,854 entitled “METHOD FOR EVALUATING CONSENSUS CREDIT SPREAD”, filed Aug. 24, 2011, the entire contents of which is incorporated herein by reference.

### BACKGROUND

1. Field of the Invention

The present disclosure relates generally to fixed income instruments and more specifically to analyzing credit spreads in fixed income instruments such as bonds.

2. Description of Related Art

Fixed income instruments, such as bonds, can be issued or sold by a number of different types of entities, such as corporations and governmental entities (State, Municipal, US). Such instruments are typically issued for a fixed period of time (fixed term) and, depending upon any discount on the principal and any coupon on the instrument issue, they typically yield different amounts of cash over their term to maturity. The yield of a fixed income instrument can be higher or lower depending upon the amount of risk (credit risk) the buyer of a fixed income instrument is willing to accept and the embed options (e.g., calls and puts) offered to the issuer or bond owner. For example, Federal, State and Municipal bonds tend to offer lower yields due in large part to the low probability that the governmental entity will default on the instrument (coupon or principal). On the other hand, corporate bonds tend to offer higher yields which are commensurate with the probability that the Corporate entity may not be able to make coupon or principal payments in a timely manner.

A number of rating agencies, such as Standard and Poor's and Moody's, work to quantify the amount of credit risk that is associated with any particular fixed instrument issue (US treasury bond), and their ratings are expressed in terms of “AAA”, “AA+” and so forth, with the triple A rating being the highest rating. Each of these rating agencies has their own proprietary method for evaluating and quantifying the credit risk associated with different types of investment instruments, but they all typically employ several common metrics such as interest-coverage ratios, capitalization ratios, call risk and event risk.

Credit spread or spread is a term that is used to describe the difference in yield between two fixed income securities, such as the difference in yield between a particular corporate bond and particular government bond. Credit spread is typically expressed in terms of basis points (bps), with one basis point being equivalent to one-hundredth of a percentage point or 0.01%. There are several means used to measure credit spread, two of which are Z-spread and option-adjusted spread. Also, there are a number of market factors that are typically used in order to quantify credit spread. These market factors can include, but are not limited to, profitability of a corporation, the asset quality (i.e., risk of loan loss), liquidity of the instrument, the size of the corporation and the corporation's real-estate holdings. The profitability of a corporation can be measured by its net interest margin, the asset quality can typically be measured using a non-performing asset ratio, liquidity can typically be quantified using the bid-ask spread measure or capital market dependency or new issues, the size of a corporate can be measured by its gross sales, and its real-estate holdings can be measured by a dollar value.

Credit spread is one metric that can be used by financial professionals when making bond transaction decisions/recommendations, such as buy/sell/hold decisions or portfolio asset allocation decisions, such as over or underweighting a sector. Therefore, correctly quantifying credit spread for a particular issue can be a very important metric in the investment decision process.

### BRIEF DESCRIPTION OF THE DRAWINGS

FIG. 1 is a diagram of a financial services network 10.

FIG. 2 is a block diagram illustrating functionality associated with one element of the network 10.

FIG. 3 is a block diagram of a collection module 22.

FIG. 4 is a diagram illustrating the format of a screen used by a financial professional to enter factor information.

FIG. 5 is a diagram showing the quantification of factor frequencies.

FIG. 6 is a diagram illustrating a DBMS file format that can be used to store factor information.

FIG. 7A is a diagram of a synthesis module.

FIG. 7B is a diagram showing the component applications comprising analysis applications.

FIG. 8 is a diagram of a mathematical model that can be used to generate an equation used to calculate a credit spread.

FIG. 9 is a diagram illustrating a format for reporting the contribution of factor information to credit spread.

FIG. 10 is a logic flow diagram of one embodiment of a process that can be followed to determine a credit spread.

### DETAILED DESCRIPTION

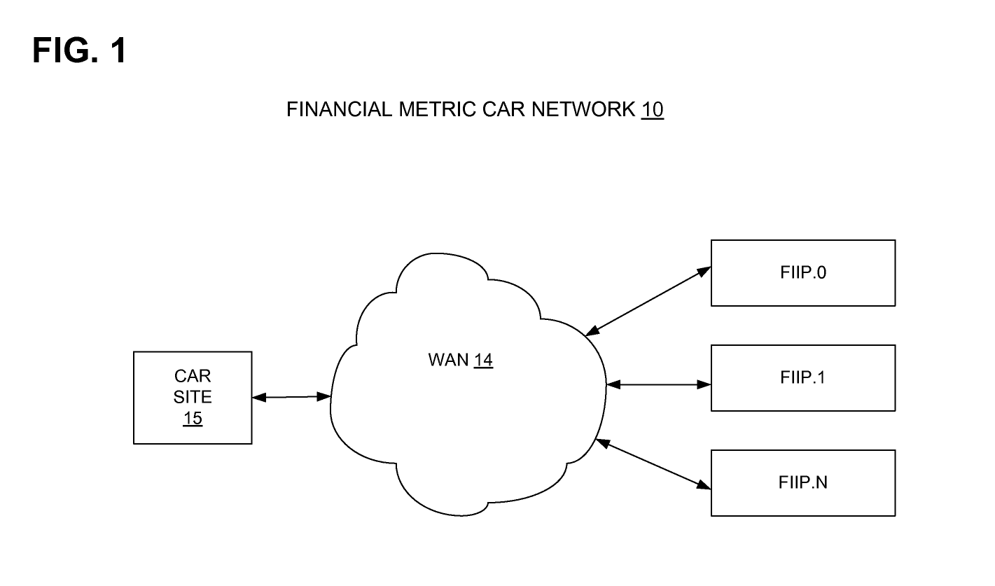

FIG. 1 is a diagram illustrating the network components that can comprise a financial metric collection, analysis and reporting network 10 (Network 10). This Network can include some number of fixed income instrument professional (FIIP) sites, FIIP.0-FIIP.N, in communication over a wide area network, WAN 14, with a financial metric collection, analysis and reporting (CAR) or simply the financial metric application at a site 15. The WAN 14 can be any network, such as the Internet, able to support the communication protocol(s) employed by the CAR application and the FIIPs to send and receive information to each other. The CAR site 15 and each of the FIIP sites can be comprised of one or more servers or computational devices having non-transitory computer readable storage, and the CAR application can be stored in the non-transitory computer readable storage in the form of specially programmed computer code or instructions. According to one embodiment, the information sent by the FIIPs to the CAR application can include, among other things, market factor information relating to particular fixed income instrument issues, and the information sent by the CAR application to the FIIPs can be, among other things, reports that include analysis of the market factors contributing to the pricing and credit spread (spread) for one or more fixed income instrument issues. An “issue” in this context means one particular fixed income instrument issued by a particular entity, which for example could be a 5-year bond issued by the US government with a principal value at maturity of $1000 and a coupon of 2.5%.

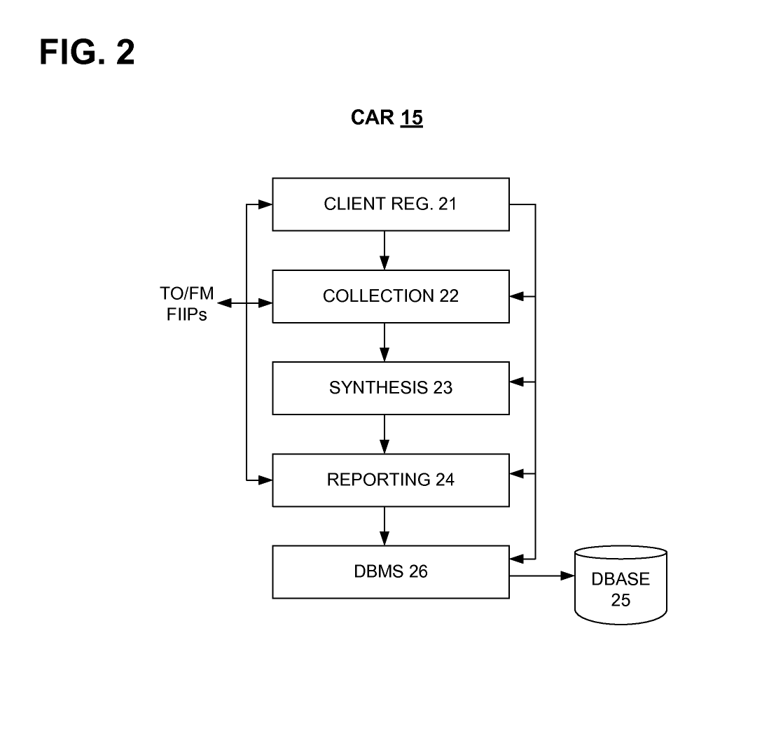

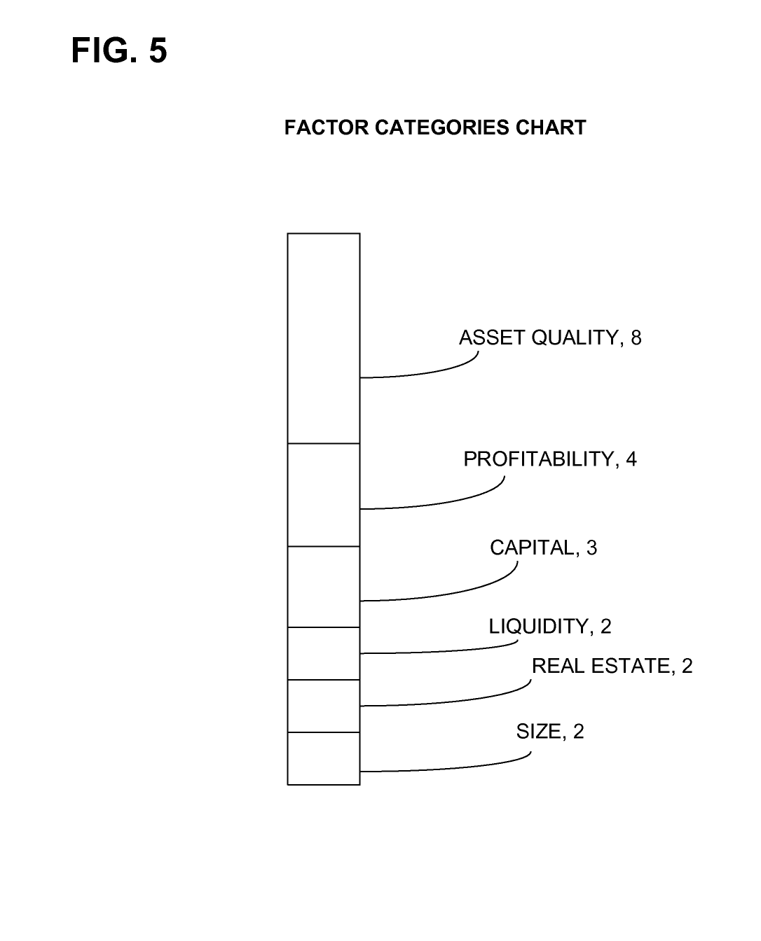

FIG. 2 illustrates the functional elements that can comprise the CAR application. As described above, the CAR application can be stored and run on any computational device having, among other things, a processor and non-transitory computer readable storage. The CAR application is comprised of a client registration module 21, a market factors collection module 22, a market factors synthesis/analysis module 23, and a reporting module 24. The CAR application can be in communication with a data base management system (DBMS) or file system 26. The DBMS or file system can be associated with a mass storage device 25 (disk) that is suitable for maintaining information received from the FIIPs and for maintaining the results of the analysis process 23. Specifically, client (FIIPs) registration can include a process for determining whether or not a particular FIIP is qualified to submit market factor information about a particular market sector. The term market sector is used here to describe a set of businesses that are buying and selling goods and services such that they are in direct competition with each other. Financial services, energy, basic materials, consumer services, industrials, technology are just a few market sectors to which market factors can be applied. The market factor collection module 22 generally operates to receive market factor information from the FIIPs, to organize this information into factor categories and to quantify the frequency with which each factor category is received by the FIIPs, and to order the factor categories according to this frequency. The results of the frequency quantification and ordering process are shown later with reference to FIG. 5.

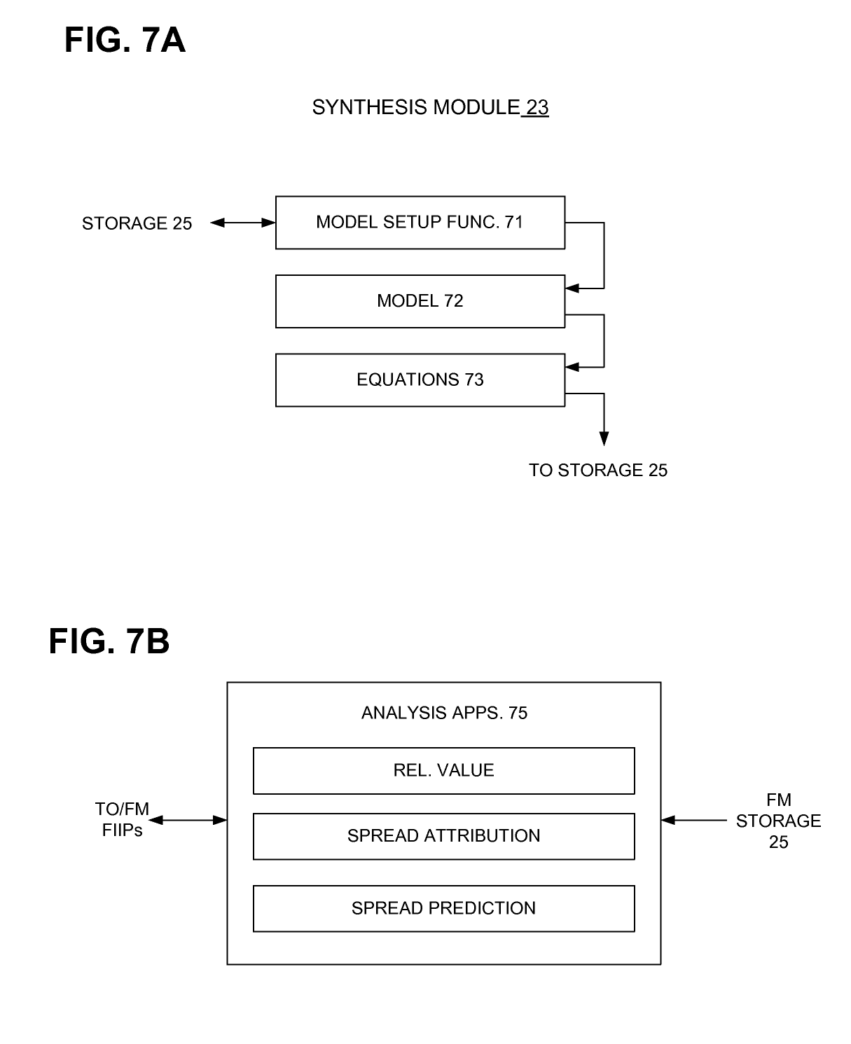

Continuing to refer to FIG. 2, the synthesis/analysis module 23, referred to herein after as simply the synthesis module 23, generally operates to run a mathematical model which is comprised of a dependent and one or more independent variables. More specifically, the mathematical model is run in order to generate a plurality of equations into each one of which is entered a dependent variable value and one or more independent variable values. The dependent variable in the model can be credit spread (Spread) or an element of pricing. The term Credit Spread in this context is used to describe the difference in yield between two fixed income securities, such as the difference in yield between a particular corporate bond and particular government bond, for example. Pricing elements can include such things as an issue's bid, ask or mid-price, yield, duration or principal amount (with premium or discount) and coupon. The dependent variable in the model is evaluated against the one or more independent variables as will be described in detail later with reference to FIG. 7. The independent variables employed by the model can be measurement information (quantitative or qualitative) associated with factor categories. The factors can be categorized by profitability, asset quality, liquidity, entity size and real estate owned by, to name only four categories. Each category can be comprised of one or more measures, such as net interest margin (associated with profitability) or loan loss provision (associated with asset quality). In operation, the module 23 evaluates the model against a plurality of samples received from the FIIPs. Typically, the samples that are evaluated by the model are all received during a specified period of time and relate to market factors associated with a group of fixed income instrument issues in a particular market sector. A sample in this case is comprised of market factors and measurement information received from a particular FIIP, on a particular date, relating to a particular market sector. A more detailed description of the mathematical model operation will be undertaken later with reference to FIG. 7.

And finally, the reporting module 24 shown in FIG. 2 operates to permit access by registered FIIPs to the results of the synthesis process and to analysis applications such as a relative value application, a spread attribution application and a spread prediction application. Generally, the relative value application compares the mathematical model spread to an actual spread, the spread attribution application operates to evaluate the contribution/influence that one or more market factors (and their associated measures) have on the mathematical model spread, and the spread prediction application is an interactive tool that can be used by the FIIPs to affect potential implications on the mathematical model spread by changing market factor values based on in-house or personal expectations.

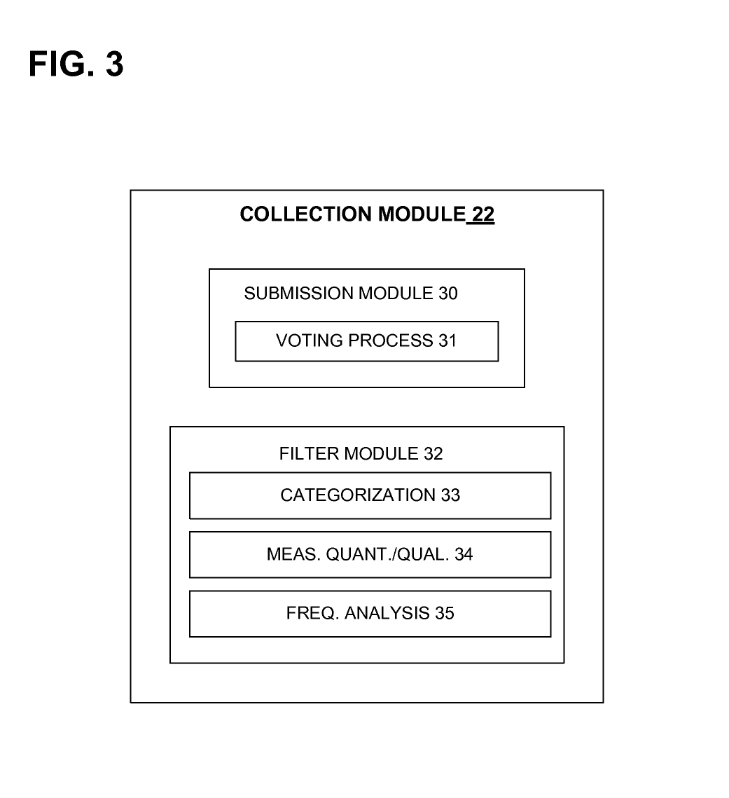

FIG. 3 shows functionality that can be employed by the collection module 22. The collection module can include a market factor submission/reception module/client 30 and a filter module 32. The reception module 30 can be comprised of one or more a sector voting processes 31 each of which is dedicated to one market sector, and each of which generally include functionality that prompts each FIIP through the market factor submission process. The filter module 32 can include a market factor categorization process 33, a factor measure quantitative/qualitative process 34, and a factor frequency analysis module 35. The factor categorization process 33 operates to examine market factor information (among other things this can be factor measurement information such as profitability, asset quality) received from a FIIP to determine which market factor category the information belongs to. The market factor measurement quantitative/qualitative analysis process 34 operates to associate a quantitative or qualitative value with each market factor measure received from a FIIP, and the market factor frequency analysis module 35 operates to quantify and order the frequency with which each market factor category (per sector) is submitted by the FIIPs during a single session. For the purposes of this description, a session is comprised of FIIP submissions received by the CAR APPLICATION during a specified period of time for a specified fixed income instrument issue.

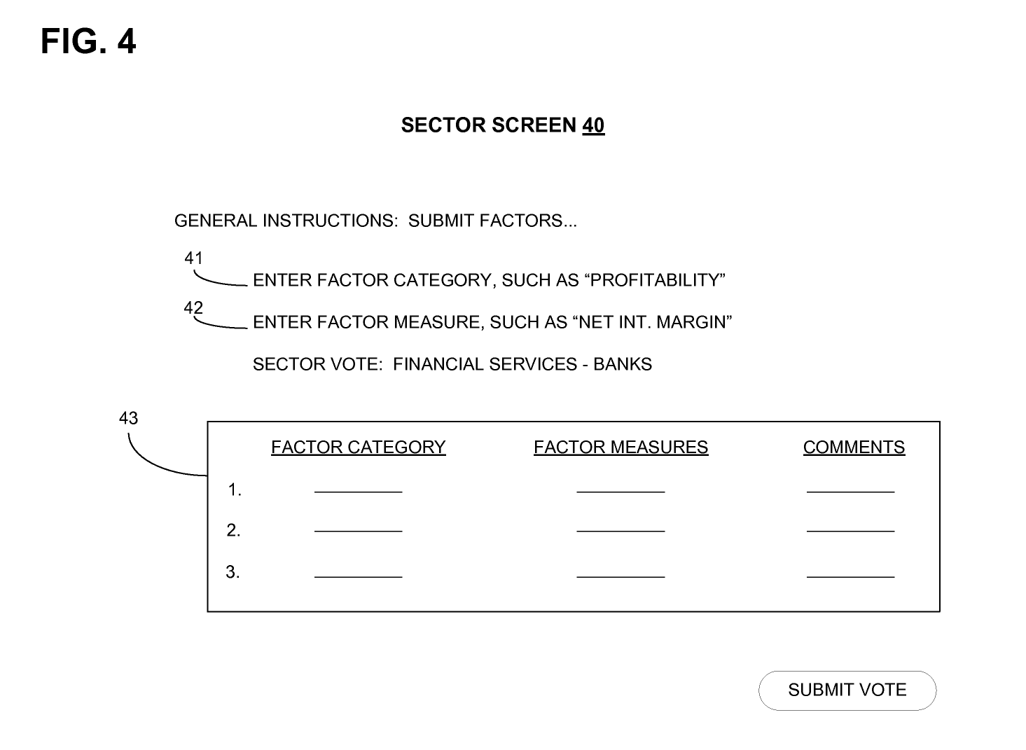

FIG. 4 is an illustration of a general screen format that can be used by a FIIP to enter market factor information (factor categories, factor measures, and comments) for submission to the CAR APPLICATION. A number of different screens can be designed, using this general format, for use by a FIIP to enter and submit market factor information. The functionality associated with each screen can be stored in storage 25 of FIG. 2, and the market factor submission module 30 of FIG. 3 can make these screens available to a FIIP upon request. Alternatively, each reception module/client 30 can be stored on a computational device located at a FIIP's principle location. The screen 40 illustrated in FIG. 4 indicates to a FIIP that the screen can be used to submit factors for at least one sector (such as financial services or a government municipality), a field 41 can prompt the FIIP to enter a particular factor category (such as profitability) and another field 42 can prompt the FIIP to enter a measure associated with each factor category (such as net interest margin). All of the information entered by the FIIP is displayed in a field 43 on the screen and can be submitted to the CAR APPLICATION by selecting the “Submit Vote” key at the bottom and right of the screen 40. Alternatively, a FIIP can ignore an auto-populate feature of the collection process and enter market factors and measures not included in the screen prompts. Regardless, the filter module 32 in the collection module 22 determines which of a plurality of standard market factor categories information submitted by a FIIP falls under, and stores this information or the information is sent to the DBMS 26 for maintenance in the storage device 25.

FIG. 5 illustrates the display format for the output of the market factor categorization process 33. Six market factor categories are illustrated in a column format. Each of six sections of the vertical dimension of the column is associated with one of the market factor categories, with the dimension of each segment directly relating to the frequency with which a factor category was detected during a session. In this case the market factor category “asset quality” was detected eight (8) times during the session of interest, profitability was detected four (4) times and so forth.

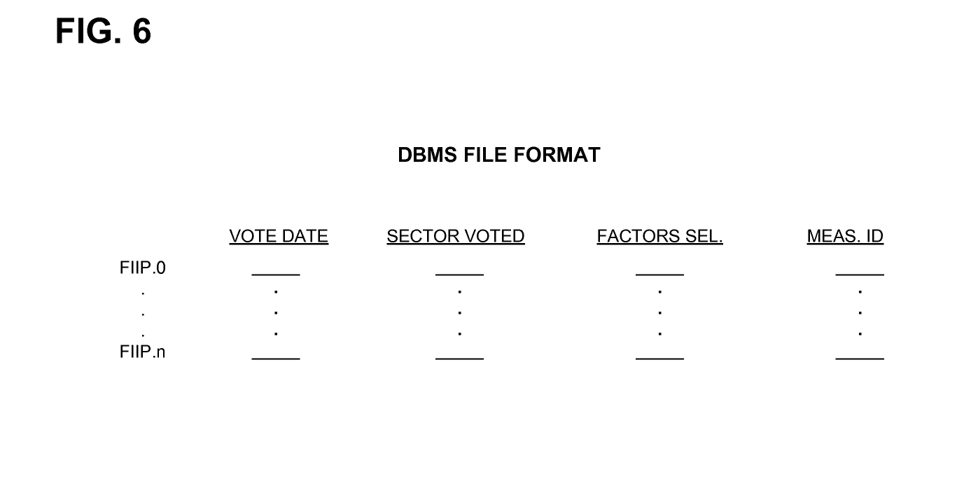

FIG. 6 illustrates an example of a file format that can be employed by the DBMS 26 to store market factor information received from the FIIPs. Each row in the format can store information submitted by a different FIIP, and each column in the format can store information about a particular voting session and market factor information submitted by the FIIPs during the session, such as, but not limited to, vote date, sector voted, factors selected and measures identified. Additional information stored by DBMS 26 includes attributes of the FIIP, including title, firm name and employer's assets under management. These attributes in DBMS 26 enable customized reporting of FIIPs market factor information.

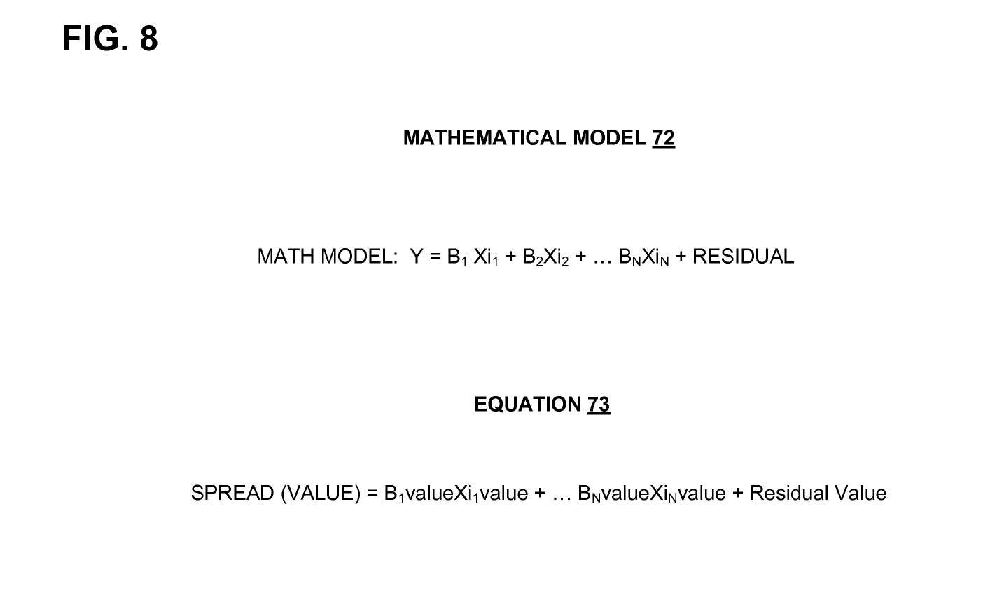

FIG. 7A is a diagram showing the functional elements comprising the synthesis module 23. This module can include, among other things, a mathematical model setup function 71, a mathematical model 72 and equations 73. The setup function operates under the general control of a CAR APPLICATION administrator (not shown) to selectively enter market factor information into the mathematical model 72 against which a financial metric, such as Spread, can be evaluated. The setup function also enables the automatic population of market factor information to mathematical model 72. In one embodiment, the mathematical model 72 is used to generate the equations 73 into which are entered variable values and which can then be used to calculate a financial metric such as Spread. The object of running the model is to generate a plurality of equations which can be used to determine the effect that selectively modifying factor measures (changing the values of) has on a dependent variable, which in this case is a financial metric such as Spread. A more detailed description of these equations is undertaken with respect to FIG. 8. The results of the equations can be sent to the DBMS 26 which stores the results in the storage device 25.

FIG. 7B is a diagram illustrating the functional elements that can be included in analysis applications' module 75 described earlier with reference to FIG. 2.

FIG. 8 shows an embodiment of the mathematical model 72 described with reference to FIG. 7A. The mathematical model in this embodiment is used to generate one or more equations 73 that are used calculate a consensus view of a financial metric, such as Spread or Pricing of a fixed financial instrument issue. The mathematical model in one embodiment is a regression function that is used to generate the plurality of equations 73. In one embodiment, a publically available current Spread value can be entered into the dependent variable term “Y” of the equations 73 of FIG. 8. As describe earlier, this Spread is typically the difference in yield between the fixed income instrument issue being analyzed and a risk free bond. The dependent variable “Spread” is then evaluated against the independent variables “X” which include some or all of the market factor information (factor measures) collected from FIIPs during a session, such as net interest margin, non-performing asset ratio, bid-ask spread measure to name only three. Each of one or more independent variables can be a function of an unknown parameter “B” and residual parameters can be added as well. “i” represents an observation number which in this case can be equivalent to information associated with a set of market factors submitted by a FIIP during a single session. The results of multiple iterations of the equation 73 is a consensus Spread value and some indication of the contribution of each independent variable to the Spread, and these results can be stored in the computer storage described earlier with reference to FIG. 2.

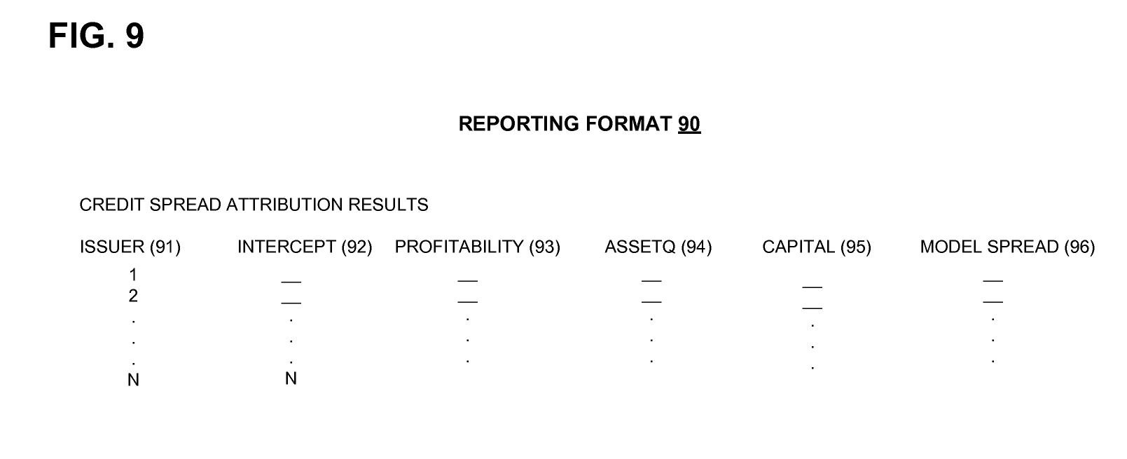

FIG. 9 is an illustration of a format 90 that can be used to report the results of the mathematical function 72 described earlier with reference to FIG. 8. The issuer of a fixed income instrument 91 can be listed in column one, the intercept 92 associated with each issuer's instrument can be listed in column two, and the market factor measures against which Spread is evaluated can be included in the remaining four columns, or however many columns are needed. The values of this information (intercept and market factor measures) can be expressed in basis points or percentage points or in some other manner.

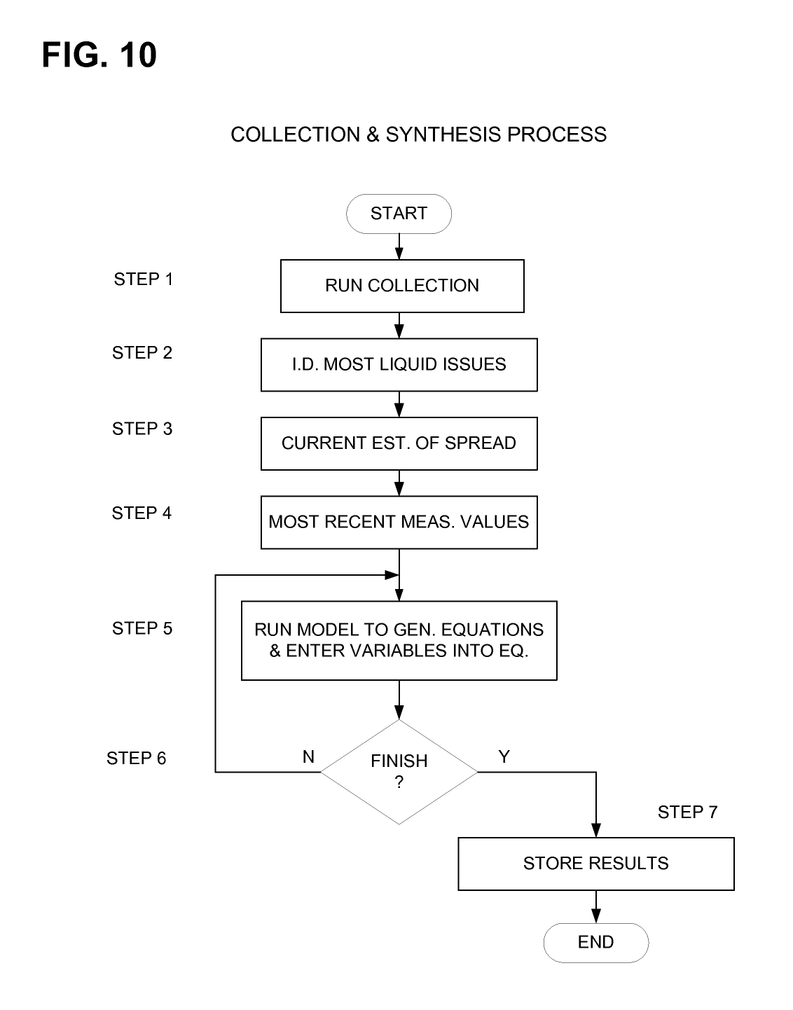

FIG. 10 is a logical flow diagram of an embodiment of the process used to arrive at a consensus Spread value. In step 1, the market factor collection process is run as described earlier with FIG. 3. In step 2, the most liquid fixed income instrument issues are identified per issuer to serve as a representative issue for the regression analysis described earlier with reference to FIG. 8. The most liquid fixed income instrument is identified to ensure that the most relevant dependent data point is analyzed; however, it should be understood that it can be identified at any step in the process. Further, after the equation is run on the most liquid issue, the ensuing equation is run on all issues (on a daily basis) using spread as the dependent variable. Then, in step 3, the current publically available Spread value associated with the issue is identified, and in step 4 the most recently collected market factor measures and their values are identified, which are, in step 5, entered into the independent variables included in the equation 73 generated by the mathematical model 72. The mathematical model (which is a regression function) is run to generate the equation 73 a plurality of times (typically many hundreds or thousands of iterations) until the regression finishes (this is the step 5 and step 6 loop). In step 7 the results of the analysis in step 5 are sent to the DBMS 26 which stores them in the storage device 25 for use by the analytical applications.

We claim:

1. A method for identifying a contribution of a consensus market factor measure to a fixed income financial instrument metric, comprising:
storing instructions in a non-transitory computer readable storage device that, when executed by a processor, cause the processor to run a financial metric application to qualify a plurality of fixed income instrument professionals;
receiving at the financial metric application, during a specified period of time from each of the plurality of the qualified, fixed income professionals, a plurality of consensus market factor measures which each of the plurality of the qualified, fixed income professionals believes is contributing to the metric associated with the fixed income financial instrument, each one of the plurality of the consensus market factor measures is distinctly associated by the financial metric application with one of a market factor category;
assigning a value to each of the plurality of the consensus market factor measures received from the fixed income professionals and quantifying the frequency with which each factor category associated with a consensus market factor measure is submitted by the plurality of fixed income professionals during the specified period of time; and
repeatedly evaluating the fixed income financial instrument metric against two or more of the plurality of the consensus market factor measure values associated with the corresponding most frequently submitted two or more market factor categories to identify the contribution of at least one consensus market factor measure to the fixed income financial instrument metric, such that the metric is evaluated during each repetition against at least one market factor measure that is distinctly different than during any other repetition of the fixed income financial instrument metric evaluation.

2. The method of claim 1, further comprising the financial metric application causing the contribution of each of the consensus market factor measures to the fixed income financial instrument metric to be displayed on a computer display device.

3. The method of claim 1, wherein the fixed income financial instrument is a bond.

4. The method of claim 1, wherein the market factor category is any one or more of a profitability, asset quality, liquidity, entity size and real estate owned.

5. The method of claim 1, wherein the market factor measure is any one or more of a net interest margin, loan loss provision, non-performing asset ratio and bid-ask spread measure.

6. The method of claim 1, wherein the metric is one or a fixed income financial instrument yield or pricing.

7. The method of claim 1, wherein the value assigned to each of the plurality of the market factor measures is an integer value.

8. A method for determining a fixed income financial instrument metric value; comprising:
storing instructions in a non-transitory computer readable storage device that, when executed by a computer processor, causes the processor to run a financial metric application to qualify a plurality of fixed income instrument professionals;
receiving at the financial metric application, during a specified period of time from each of the plurality of the qualified, fixed income professionals, a plurality of consensus market factor measures which each of the plurality of the qualified, fixed income professionals believes is contributing to the metric associated with the fixed income financial instrument, each one of the plurality of consensus market factor measures is distinctly associated with one of a market factor category;
assigning a value to each of the consensus market factor measures received from the fixed income professionals and quantifying the frequency with which each factor category associated with a consensus market factor measure is submitted by the plurality of fixed income professionals during the specified period of time; and
repeatedly evaluating the fixed income financial instrument metric each time against a different set of the plurality of the consensus market factor measure values associated with the corresponding most frequently submitted two or more market factor categories to determine a fixed income financial instrument metric value.

9. The method of claim 8, further comprising the financial metric application causing the value of the consensus fixed income financial instrument metric to be displayed on a computer display device.

10. The method of claim 8, wherein the fixed income financial instrument is a bond.

11. The method of claim 10, wherein the bond is a government bond or a corporate bond.

12. The method of claim 11, wherein the market factor category is any one or more of a profitability, asset quality, liquidity, entity size and real estate owned.

13. The method of claim 8, wherein the consensus market factor measure is any one or more of a net interest margin, loan loss provision, non-performing asset ratio and bid-ask spread measure.

14. The method of claim 8, wherein the fixed income financial instrument metric is one of a fixed income financial instrument yield or pricing.

15. The method of claim 8, wherein the value assigned to each of the plurality of the consensus market factor measures is an integer value.

16. A non-transitory computer readable storage device comprising instructions that, when executed by a processor, cause the processor to run a financial metric application, the financial metric application having:
a client registration module, a collection module, a synthesis module, and a reporting module that operate to qualify a plurality of fixed income instrument professionals, to receive a plurality of consensus market factor measures from each of the plurality of fixed income professionals and associating each consensus market factor measure with a distinct market factor category, to assign a value to each of the consensus market factor measures and to quantify the frequency with which each factor category associated with a consensus market factor measure is received, and repeatedly evaluating a fixed income financial instrument metric each time against a different set of the plurality of the consensus market factors measure values associated with the corresponding most frequently submitted two or more market factor categories to determine a fixed income financial instrument metric value.
